(19) United States
(12) Patent Application Publication
(10) Pub. No.: US 2026/0346856 A1
(43) Pub. Date: Nov. 5, 2026

(54) TRAVEL CONTROL DEVICE, TRAVEL CONTROL METHOD, AND STORAGE MEDIUM

(71) Applicant: HONDA MOTOR CO., LTD., Tokyo (JP)

(72) Inventor: Daichi Inoue, Tokyo (JP)

(21) Appl. No.: 19/550,321

(22) Filed: Feb. 26, 2026

(30) Foreign Application Priority Data
Mar. 19, 2025 (JP) 2025-045338

(51) Int. Cl. B60W 50/02; B60W 30/095; B60W 30/12

(52) U.S. Cl. CPC B60W 50/0205; B60W 30/0956; B60W 30/12; B60W 2050/0215; B60W 2552/50; B60W 2552/53

(57) ABSTRACT

A travel control device according to an embodiment comprises: a recognizer that recognizes surrounding situations including a first and a second lane marking; a selector that selects either one lane marking; and a travel controller that executes travel control of a host vehicle based on the selected lane marking, a reliability determiner that determines respective reliabilities of the first and the second lane marking based on travel trajectories of other vehicles when a predetermined number or more of other vehicles are recognized; and a margin determiner that determines a margin until a preceding vehicle interferes with the first and the second lane marking based on a travel trajectory of the preceding vehicle when a preceding vehicle traveling ahead of the host vehicle is recognized, and determines whether or not to select the second lane marking based on the reliability and the margin.

### CROSS-REFERENCE TO RELATED APPLICATION

This application claims priority based on Japanese Patent Application No. 2025-045338 filed on Mar. 19, 2025, the contents of which are incorporated herein by reference.

### BACKGROUND

### Field of the Invention

The present invention relates to a travel control device, a travel control method, and a storage medium.

### Description of Related Art

In recent years, efforts to provide access to sustainable transportation systems with consideration for vulnerable people among traffic participants have been intensifying. To realize this, research and development are being focused on further improving traffic safety and convenience through research and development related to automated driving technology. Related to this, conventionally, a technology is known in which road shapes obtained from map information and travel trajectories of preceding vehicles are compared, and when there is a region where the shapes of both are not similar, the reliability of the map information corresponding to that region is determined to be low, and information on the determined reliability is output to a driving assistance device (for example, Japanese Unexamined Patent Application, First Publication No.

### SUMMARY

By the way, in conventional automated driving technology, there have been cases where the determination accuracy for lane markings decreases depending on the recognition situation of the vehicle surroundings. Therefore, there has been an issue that appropriate travel control based on lane markings cannot be executed in some cases.

In order to solve the above issue, one of the objects of the present application is to provide a travel control device, a travel control method, and a storage medium that can execute more appropriate travel control based on the recognition situation of the vehicle surroundings. Furthermore, it contributes to the development of sustainable transportation systems.

The travel control device, travel control method, and storage medium according to the present invention adopt the following configurations.
(1): A travel control device according to one aspect of the present invention comprises: a first recognizer that recognizes surrounding situations including a first lane marking that demarcates a lane around the host vehicle based on an output of a detection device that has detected the surrounding situation of the host vehicle; a second recognizer that recognizes a second lane marking that demarcates a lane around the host vehicle from map information based on position information of the host vehicle; a determiner that determines whether or not the first lane marking and the second lane marking match; a selector that selects either one lane marking among the first lane marking and the second lane marking when the determiner determines that the first lane marking and the second lane marking do not match; and a travel controller that executes travel control of the host vehicle based on the lane marking selected by the selector, wherein the determiner comprises: a reliability determiner that determines respective reliabilities of the first lane marking and the second lane marking based on travel trajectories of the other vehicles when a predetermined number or more of other vehicles are recognized by the first recognizer; and a margin determiner that determines a margin until the preceding vehicle interferes with the first lane marking and the second lane marking based on a travel trajectory of the preceding vehicle when a preceding vehicle traveling ahead of the host vehicle is recognized by the first recognizer, and the selector determines whether or not to select the second lane marking based on the reliability and the margin.
(2): In the aspect of (1) above, the reliability determiner determines that selection of the second lane marking is possible when the reliability of the first lane marking is determined to be incorrect and the reliability of the second lane marking is determined to be correct.
(3): In the aspect of (2) above, the margin determiner determines that selection of the second lane marking is possible when the margin of a travel path of the first lane marking is determined to be absent and the margin of a travel path of the second lane marking is determined to be present.
(4): In the aspect of (3) above, the margin determiner performs a first derivation process of deriving a first margin based on a position when the preceding vehicle travels straight in the current traveling direction and interferes with the first lane marking and the second lane marking, and a second derivation process of deriving a second margin based on a preset position where the preceding vehicle is determined to have a possibility of interfering with the first lane marking and the second lane marking, and determines the margin based on respective processing results of the first derivation process and the second derivation process.
(5): In the aspect of (4) above, the margin determiner selects, as the margin for the second lane marking, the margin with the smaller value among the first margin and the second margin, and selects, as the margin for the first lane marking, the margin with the larger value among the first margin and the second margin.
(6): In the aspect of (1) above, the first recognizer recognizes the preceding vehicle and also recognizes a physical boundary provided at a position where the host vehicle can move without interfering, and the determiner determines whether or not the first lane marking is erroneously recognized based on the travel trajectory of the preceding vehicle and the physical boundary.
(7): A travel control method according to one aspect of the present invention is a travel control method in which a computer recognizes surrounding situations including a first lane marking that demarcates a lane around the host vehicle based on an output of a detection device that has detected the surrounding situation of the host vehicle, recognizes a second lane marking that demarcates a lane around the host vehicle from map information based on position information of the host vehicle, determines whether or not the first lane marking and the second lane marking match, selects either one lane marking among the first lane marking and the second lane marking when it is determined that the first lane marking and the second lane marking do not match, executes travel control of the host vehicle based on the selected lane marking, determines respective reliabilities of the first lane marking and the second lane marking based on travel trajectories of the other vehicles when a predetermined number or more of other vehicles are recognized, determines a margin until the preceding vehicle interferes with the first lane marking and the second lane marking based on a travel trajectory of the preceding vehicle when a preceding vehicle traveling ahead of the host vehicle is recognized, and determines whether or not to select the second lane marking based on the reliability and the margin.
(8): A storage medium according to one aspect of the present invention is a computer-readable non-transitory storage medium storing a program that causes a computer to: recognize surrounding situations including a first lane marking that demarcates a lane around the host vehicle based on an output of a detection device that has detected the surrounding situation of the host vehicle; recognize a second lane marking that demarcates a lane around the host vehicle from map information based on position information of the host vehicle; determine whether or not the first lane marking and the second lane marking match; select either one lane marking among the first lane marking and the second lane marking when it is determined that the first lane marking and the second lane marking do not match; execute travel control of the host vehicle based on the selected lane marking; determine respective reliabilities of the first lane marking and the second lane marking based on travel trajectories of the other vehicles when a predetermined number or more of other vehicles are recognized; determine a margin until the preceding vehicle interferes with the first lane marking and the second lane marking based on a travel trajectory of the preceding vehicle when a preceding vehicle traveling ahead of the host vehicle is recognized; and determine whether or not to select the second lane marking based on the reliability and the margin.

According to the aspects of (1) to (8) above, more appropriate travel control can be executed based on the recognition situation of the vehicle surroundings.

### BRIEF DESCRIPTION OF THE DRAWINGS

FIG. 1 is a configuration diagram of a vehicle system including a travel control device according to an embodiment.

FIG. 2 is a functional configuration diagram of a first controller and a second controller.

FIG. 3 is a diagram showing an example of determination processing executed by a determiner.

FIG. 4 is a diagram for explaining details of a first determination process.

FIG. 5 is a diagram for explaining details of a second determination process.

FIG. 6 is a diagram for explaining details of a third determination process.

FIG. 7 is a diagram for explaining an example of determination content of the third determination process.

FIG. 8 is a diagram (part 1) for explaining details of a fourth determination process.

FIG. 9 is a diagram (part 2) for explaining details of the fourth determination process.

FIG. 10 is a diagram for explaining a first derivation process of interference margin time TTLC.

FIG. 11 is a diagram for explaining a second derivation process of interference margin time TTLC.

FIG. 12 is a flowchart showing an example of a flow of processing executed by an automated driving control device.

FIG. 13 is a flowchart showing an example of various determination processes.

FIG. 14 is a flowchart showing another example of various determination processes.

### DESCRIPTION OF EMBODIMENTS

Hereinafter, embodiments of the travel control device, travel control method, and storage medium of the present invention will be described with reference to the drawings. In the following, as an example, an embodiment in which the travel control device is applied to an automated driving vehicle will be described. Automated driving is, for example, automatically controlling one or both of steering or speed of a vehicle to execute travel control. The above-described travel control may include, for example, travel control of ACC (Adaptive Cruise Control System), TJP (Traffic Jam Pilot), LKAS (Lane Keeping Assistance System), ALC (Automated Lane Change), and CMBS (Collision Mitigation Brake System). In addition, the automated driving vehicle may execute travel control by manual operation of a user (for example, an occupant) of the vehicle (so-called manual driving).

### Overall Configuration

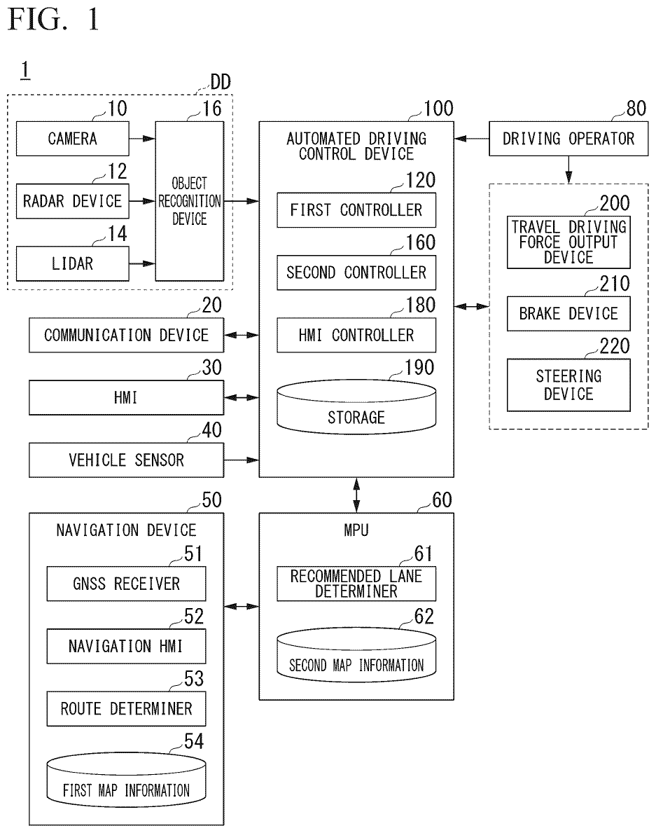

FIG. 1 is a configuration diagram of a vehicle system 1 including a travel control device according to an embodiment. A vehicle (hereinafter referred to as host vehicle M) in which the vehicle system 1 is mounted is, for example, a two-wheeled, three-wheeled, four-wheeled, or other vehicle, and its drive source is an internal combustion engine such as a diesel engine or gasoline engine, an electric motor, or a combination thereof. The electric motor operates using electric power generated by a generator connected to the internal combustion engine, or discharge power of a battery (storage battery) such as a secondary battery or fuel cell.

The vehicle system 1 includes, for example, a camera 10, a radar device 12, a LIDAR (Light Detection and Ranging) 14, an object recognition device 16, a communication device 20, an HMI (Human Machine Interface) 30, a vehicle sensor 40, a navigation device 50, an MPU (Map Positioning Unit) 60, a driving operator 80, an automated driving control device 100, a travel driving force output device 200, a brake device 210, and a steering device 220. These devices and equipment are connected to each other by a multiplex communication line such as a CAN (Controller Area Network) communication line, a serial communication line, a wireless communication network, or the like. Note that the configuration shown in FIG. 1 is merely an example, and a part of the configuration may be omitted, or another configuration may be added. The camera 10 is an example of an “imaging unit”. A combination of the camera 10, the radar device 12, the LIDAR 14, and the object recognition device 16 is an example of a “detection device DD”. The HMI 30 is an example of an “output device”. The automated driving control device 100 is an example of a “travel control device”.

The camera 10 is, for example, a digital camera using a solid-state imaging element such as a CCD (Charge Coupled Device) or CMOS (Complementary Metal Oxide Semiconductor). The camera 10 is attached to an arbitrary location of the host vehicle M in which the vehicle system 1 is mounted. When imaging the front, the camera 10 is attached to an upper part of a front windshield, a back surface of a rearview mirror, a front part of a vehicle body, or the like. When imaging the rear, the camera 10 is attached to an upper part of a rear windshield, a back door, or the like. When imaging the side, the camera 10 is attached to a door mirror or the like. The camera 10, for example, periodically and repeatedly images the surroundings of the host vehicle M. The camera 10 may be a stereo camera.

The radar device 12 radiates radio waves such as millimeter waves to the surroundings of the host vehicle M and detects radio waves (reflected waves) reflected by surrounding objects to detect at least the position (distance and direction) of the object. The radar device 12 is attached to an arbitrary location of the host vehicle M. The radar device 12 may detect the position and velocity of an object by an FM-CW (Frequency Modulated Continuous Wave) method.

The LIDAR 14 irradiates light to the surroundings of the host vehicle M and measures scattered light. The LIDAR 14 detects the distance to a target based on the time from light emission to light reception. The irradiated light is, for example, pulsed laser light. The LIDAR 14 is attached to an arbitrary location of the host vehicle M.

The object recognition device 16 performs sensor fusion processing on detection results by some or all of the camera 10, the radar device 12, and the LIDAR 14 to recognize the position, type, velocity, and the like of objects. The object recognition device 16 outputs the recognition result to the automated driving control device 100. In addition, the object recognition device 16 may output the detection results of the camera 10, the radar device 12, and the LIDAR 14 as they are to the automated driving control device 100. In that case, the object recognition device 16 may be omitted from the configuration of the vehicle system 1 (detection device DD).

The communication device 20 communicates with, for example, other vehicles existing around the host vehicle M, a terminal device of a user who uses the host vehicle M, or various server devices, using a network such as a cellular network, Wi-Fi network, Bluetooth (registered trademark), DSRC (Dedicated Short Range Communication), LAN (Local Area Network), WAN (Wide Area Network), or the Internet.

The HMI 30 outputs various information to occupants of the host vehicle M and accepts input operations by the occupants. The HMI 30 includes, for example, various display devices, speakers, buzzers, touch panels, switches, keys, microphones, and the like.

The vehicle sensor 40 includes a vehicle speed sensor that detects the speed of the host vehicle M, an acceleration sensor that detects acceleration, a yaw rate sensor that detects a yaw rate (for example, a rotational angular velocity around a vertical axis passing through the center of gravity of the host vehicle M), a direction sensor that detects the direction of the host vehicle M, and the like. In addition, the vehicle sensor 40 may be provided with a position sensor that detects the position of the vehicle. The position sensor is, for example, a sensor that acquires position information (longitude/latitude information) from a GPS (Global Positioning System) device. In addition, the position sensor may be a sensor that acquires position information using a GNSS (Global Navigation Satellite System) receiver 51 of the navigation device 50. The vehicle sensor 40 may derive the speed of the host vehicle M from the difference (that is, distance) of position information at a predetermined time in the position sensor. The result detected by the vehicle sensor 40 is output to the automated driving control device 100.

The navigation device 50 includes, for example, a GNSS receiver 51, a navigation HMI 52, and a route determiner 53. The navigation device 50 holds first map information 54 in a storage device such as an HDD (Hard Disk Drive) or flash memory. The GNSS receiver 51 specifies the position of the host vehicle M based on signals received from GNSS satellites. The position of the host vehicle M may be specified or supplemented by an INS (Inertial Navigation System) using the output of the vehicle sensor 40. The navigation HMI 52 includes a display device, speakers, touch panels, keys, and the like. The GNSS receiver 51 may be provided in the vehicle sensor 40. The navigation HMI 52 may be partially or entirely shared with the HMI 30 described above. The route determiner 53, for example, determines a route (hereinafter, on-map route) from the position of the host vehicle M specified by the GNSS receiver 51 (or an arbitrary input position) to a destination input by an occupant using the navigation HMI 52, with reference to the first map information 54. The first map information 54 is, for example, information in which road shapes are represented by links indicating roads and nodes connected by the links. The first map information 54 may include POI (Point Of Interest) information and the like. The on-map route is output to the MPU 60. The navigation device 50 may perform route guidance using the navigation HMI 52 based on the on-map route. The navigation device 50 may transmit the current position and destination to a navigation server via the communication device 20 and acquire a route equivalent to the on-map route from the navigation server. The navigation device 50 outputs the determined on-map route to the MPU 60.

The MPU 60, for example, includes a recommended lane determiner 61 and holds second map information 62 in a storage device such as an HDD or flash memory. The recommended lane determiner 61 divides the on-map route provided from the navigation device 50 into a plurality of blocks (for example, divides every 100 [m] in the vehicle traveling direction) and determines a recommended lane for each block with reference to the second map information 62. The recommended lane determiner 61 determines which lane from the left to travel in. When a branch point exists on the on-map route, the recommended lane determiner 61 determines the recommended lane so that the host vehicle M can travel on a reasonable route for proceeding to the branch destination.

The second map information 62 is map information with higher precision than the first map information 54. The second map information 62 includes, for example, the number of lanes, types and shapes of road markings (hereinafter referred to as lane markings), information on lane centers or road boundary information, and the like. The second map information 62 may include information on whether a road boundary is a boundary (physical boundary) including a structure through which the host vehicle M cannot pass (including crossing and contacting). Physical boundaries are, for example, guardrails, curbs, median strips, fences, and the like. In addition, the second map information 62 may include road shape information, traffic regulation information, address information (address/postal code), facility information, parking lot information, telephone number information, and the like. Road shape information is, for example, curvature of a road (may be rephrased as radius of curvature; the same applies hereinafter), amount of curvature change for each predetermined distance, width, gradient, and the like.

In addition, the second map information 62 may include information on lines (center lines) indicating the center of lanes. The center line is a center line between left and right lane markings. This center line may exist in a lane where either one of the left and right lane markings demarcating the lane is interrupted. In addition, the second map information 62 may store information on branch points, merging points, lane increase/decrease points, and the like of roads. At branch points, information on branch lanes and main lines may be included, and at merging points, information on merging lanes and main lines may be included. In addition, the second map information 62 may include information on the position, type, shape, and the like of structures (structures that do not hinder travel) such as elevated roads, pedestrian bridges, and tunnels that exist straddling above lanes without touching the lanes.

The second map information 62 may be updated at any time by the communication device 20 communicating with an external device. The first map information 54 and the second map information 62 may be provided integrally as map information. In addition, the map information may be stored in a storage 190.

The driving operator 80 includes, for example, a steering wheel, an accelerator pedal, and a brake pedal. In addition, the driving operator 80 may include a shift lever, a non-circular steering wheel, a joystick, or other operators. An operation detector for detecting, for example, the operation amount of the operator by an occupant or the presence or absence of operation is attached to each operator of the driving operator 80. The operation detector detects, for example, the steering angle and steering torque of the steering wheel, the depression amount of the accelerator pedal or brake pedal, and the like. Then, the operation detector outputs the detection result to the automated driving control device 100, or to one or both of the travel driving force output device 200, the brake device 210, and the steering device 220.

The automated driving control device 100 executes various driving controls belonging to automated driving for the host vehicle M. The automated driving control device 100 includes, for example, a first controller 120, a second controller 160, an HMI controller 180, and a storage 190. The first controller 120, the second controller 160, and the HMI controller 180 are each realized, for example, by a hardware processor such as a CPU (Central Processing Unit) executing a program (software). In addition, some or all of these components may be realized by hardware (circuit unit; including circuitry) such as LSI (Large Scale Integration), ASIC (Application Specific Integrated Circuit), FPGA (Field-Programmable Gate Array), GPU (Graphics Processing Unit), or SOC (System On Chip), or may be realized by cooperation of software and hardware. The above-described program may be stored in advance in a storage device (a storage device including a non-transitory storage medium) such as an HDD or flash memory of the automated driving control device 100, or may be stored in a removable storage medium such as a DVD, CD-ROM, or memory card, and installed in the storage device of the automated driving control device 100 by mounting the storage medium (non-transitory storage medium) in a drive device or card slot.

The storage 190 may be realized by the above-described various storage devices, or an EEPROM (Electrically Erasable Programmable Read Only Memory), ROM (Read Only Memory), RAM (Random Access Memory), or the like. In the storage 190, for example, various information, programs, and the like in the embodiment are stored. In addition, map information (for example, the first map information 54 and the second map information 62) may be stored in the storage 190.

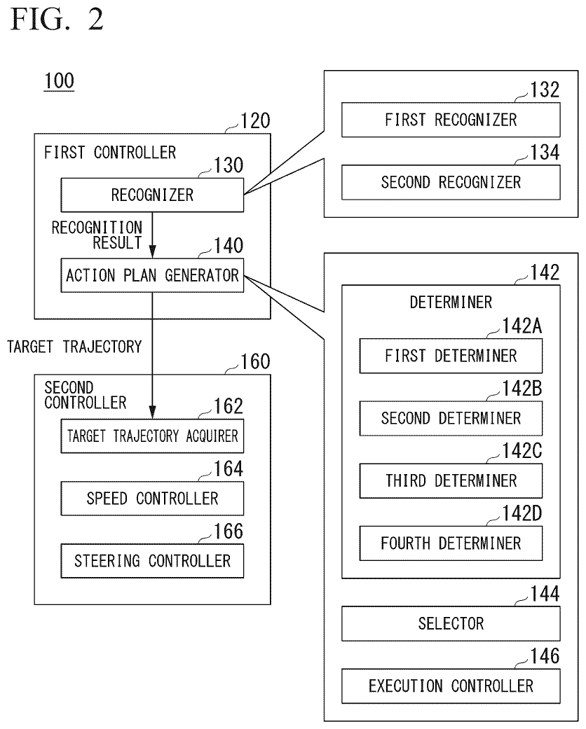

FIG. 2 is a functional configuration diagram of the first controller 120 and the second controller 160. The first controller 120 includes, for example, a recognizer 130 and an action plan generator 140. The first controller 120, for example, realizes functions by AI (Artificial Intelligence) and functions by a model given in advance in parallel. For example, the function of “recognizing an intersection” may be realized by performing recognition of an intersection by deep learning or the like and recognition based on conditions given in advance (signals that can be pattern-matched, road markings, etc.) in parallel, scoring both, and comprehensively evaluating them. This ensures the reliability of automated driving. In addition, the first controller 120 executes control related to automated driving of the host vehicle M, for example, based on instructions from the MPU 60, the HMI controller 180, or the like.

The recognizer 130 recognizes the surrounding situation of the host vehicle M based on recognition results of the detection device DD (information input from the camera 10, the radar device 12, and the LIDAR 14 via the object recognition device 16). For example, the recognizer 130 recognizes states such as the position, velocity, and acceleration of targets (objects) existing around the host vehicle M (within a predetermined distance). Targets include, for example, stationary targets and moving targets. Stationary targets include, for example, objects that cannot move by themselves, such as curbs, median strips, guardrails, fences, and other physical boundaries for demarcating roads or lanes provided at positions where the host vehicle M can move without interfering, road structures such as road signs, traffic signals, and railroad crossings, and obstacles (for example, fallen objects). Moving targets include, for example, objects that can move by themselves, such as other vehicles (surrounding vehicles) and traffic participants (bicycles, pedestrians, etc.) traveling on roads. The position of a target is, for example, recognized as a position on absolute coordinates with a representative point (center of gravity, drive shaft center, etc.) of the host vehicle M as the origin, and is used for control. The position of a target may be represented by a representative point such as the center of gravity or corner of the target, or may be represented by an expressed region. The “state” of a target may include, for example, when the target is a moving target such as another vehicle, the acceleration or jerk of the moving target, or an “action state” (for example, whether another vehicle is changing lanes or is about to change lanes).

In addition, the recognizer 130 includes, for example, a first recognizer 132 and a second recognizer 134. Details of these functions will be described later.

The action plan generator 140 generates an action plan for causing the host vehicle M to travel by automated driving based on the recognition result of the recognizer 130 and the like. For example, the action plan generator 140 basically travels in the recommended lane determined by the recommended lane determiner 61, and further generates a target trajectory that the host vehicle M will automatically travel in the future (without depending on the driver's operation) so as to be able to respond to the surrounding situation of the host vehicle M based on the recognition result by the recognizer 130 and the surrounding road shape based on the current position of the host vehicle M acquired from map information. The target trajectory includes, for example, a speed element. For example, the target trajectory is expressed as an arrangement of points (trajectory points) that the host vehicle M should reach in order. A trajectory point is a point that the host vehicle M should reach for each predetermined travel distance (for example, about several [m]) in the road-following distance, and separately from this, a target speed and target acceleration for each predetermined sampling time (for example, about several tenths of a second) are generated as part of the target trajectory. In addition, a trajectory point may be a position that the host vehicle M should reach at each sampling time for each predetermined sampling time. In this case, information on target speed and target acceleration is expressed by the interval of trajectory points.

The action plan generator 140 may set automated driving events when generating target trajectories. Events include, for example, a constant speed travel event that causes the host vehicle M to travel at a constant speed in the same lane, a following travel event that causes the host vehicle M to follow another vehicle that exists within a predetermined distance ahead of the host vehicle M (for example, within 100 [m]) and is closest to the host vehicle M, a lane change event that causes the host vehicle M to change lanes from its own lane to an adjacent lane, a branch event that causes the host vehicle M to branch to the destination side lane at a road branch point, a merging event that causes the host vehicle M to merge into a main line at a merging point, and a handover event for ending automated driving and switching to manual driving. In addition, events may include, for example, an overtaking event that causes the host vehicle M to change lanes to an adjacent lane, overtake a preceding vehicle in the adjacent lane, and then change lanes back to the original lane, and an avoidance event that causes the host vehicle M to perform at least one of braking and steering to avoid an obstacle existing ahead of the host vehicle M.

In addition, the action plan generator 140 may, for example, change an event already determined for the current section to another event or set a new event for the current section according to the surrounding situation of the host vehicle M recognized during travel of the host vehicle M. In addition, the action plan generator 140 may change an event already set for the current section to another event or set a new event for the current section according to an occupant's operation on the HMI 30. The action plan generator 140 generates a target trajectory according to the set event.

In addition, the action plan generator 140 includes, for example, a determiner 142, a selector 144, and an execution controller 146. The execution controller 146 and the second controller 160 are an example of a “travel controller”. Details of these functions will be described later.

The second controller 160 controls the travel driving force output device 200, the brake device 210, and the steering device 220 so that the host vehicle M passes through the target trajectory generated by the action plan generator 140 at the scheduled time.

The second controller 160 includes, for example, a target trajectory acquirer 162, a speed controller 164, and a steering controller 166. The target trajectory acquirer 162 acquires information on the target trajectory (trajectory points) generated by the action plan generator 140 and stores it in a memory (not shown). The speed controller 164 controls the travel driving force output device 200 or the brake device 210 based on the speed element accompanying the target trajectory stored in the memory. The steering controller 166 controls the steering device 220 according to the degree of bending of the target trajectory stored in the memory. The processing of the speed controller 164 and the steering controller 166 is realized, for example, by a combination of feedforward control and feedback control. As an example, the steering controller 166 executes a combination of feedforward control according to the curvature of the road ahead of the host vehicle M and feedback control based on deviation from the target trajectory.

Returning to FIG. 1, the HMI controller 180 notifies occupants of predetermined information by the HMI 30. The predetermined information includes, for example, information related to travel of the host vehicle M, such as information on the state of the host vehicle M and information on travel control. Information on the state of the host vehicle M includes, for example, the speed of the host vehicle M, engine speed, shift position, and the like. In addition, information on travel control includes, for example, presence or absence of execution of travel control by automated driving, information for inquiring whether to start automated driving, information on travel control status by automated driving, information on automation level, information that prompts occupants to drive when switching from automated driving to manual driving, determination results by the determiner 142, selection results by the selector 144, control results by the execution controller 146, and the like. In addition, the predetermined information may include information unrelated to travel of the host vehicle M, such as television programs and content (for example, movies) stored in storage media such as DVDs. In addition, the predetermined information may include, for example, information on the current position and destination in automated driving and the remaining fuel level of the host vehicle M. The HMI controller 180 may output information received by the HMI 30 to the communication device 20, the navigation device 50, the first controller 120, and the like.

In addition, the HMI controller 180 may cause the HMI 30 to output inquiry information to occupants, processing results by the first controller 120 and the second controller 160, and the like. In addition, the HMI controller 180 may transmit various information to be output to the HMI 30 to a terminal device used by a user of the host vehicle M via the communication device 20.

The travel driving force output device 200 outputs travel driving force (torque) for the vehicle to travel to drive wheels. The travel driving force output device 200 includes, for example, a combination of an internal combustion engine, an electric motor, a transmission, and the like, and an ECU (Electronic Control Unit) that controls these. The ECU controls the above configuration according to information input from the second controller 160 or information input from the accelerator pedal of the driving operator 80.

The brake device 210 includes, for example, a brake caliper, a cylinder that transmits hydraulic pressure to the brake caliper, an electric motor that generates hydraulic pressure in the cylinder, and a brake ECU. The brake ECU controls the electric motor according to information input from the second controller 160 or information input from the brake pedal of the driving operator 80 so that brake torque corresponding to the braking operation is output to each wheel. The brake device 210 may include, as a backup, a mechanism that transmits hydraulic pressure generated by the operation of the brake pedal to the cylinder via a master cylinder. Note that the brake device 210 is not limited to the configuration described above, and may be an electronically controlled hydraulic brake device that controls an actuator according to information input from the second controller 160 to transmit hydraulic pressure of the master cylinder to the cylinder.

The steering device 220 includes, for example, a steering ECU and an electric motor. The electric motor, for example, applies force to a rack and pinion mechanism to change the direction of steered wheels. The steering ECU drives the electric motor according to information input from the second controller 160 or information input from the steering wheel of the driving operator 80 to change the direction of the steered wheels.

### Recognizer and Action Plan Generator

Next, details of the functions of the recognizer 130 (first recognizer 132, second recognizer 134) and the action plan generator 140 (determiner 142, selector 144, execution controller 146) will be described.

The first recognizer 132 recognizes surrounding situations including camera lane markings that demarcate lanes around the host vehicle M (within a predetermined distance) based on outputs of detection devices that have detected the surrounding situation of the host vehicle M (for example, images captured by the camera 10 (hereinafter, camera images)). Camera lane markings are an example of “first lane markings”. In addition, the first recognizer 132 recognizes other vehicles existing around the host vehicle M and recognizes travel trajectories of other vehicles. Other vehicles include preceding vehicles traveling ahead in the travel lane of the host vehicle M, parallel-traveling vehicles traveling in a lane different from the travel lane of the host vehicle M and existing in the lateral direction of the host vehicle M (for example, traveling with overlapping lateral positions), and other surrounding vehicles (for example, following vehicles, etc.). Travel trajectories may be past travel trajectories and may include future trajectories predicted from past travel trajectories. The second recognizer 134 recognizes map lane markings that demarcate lanes around the host vehicle M from map information based on position information of the host vehicle M, such as that included in the vehicle sensor 40. Map lane markings are an example of “second lane markings”. In addition, the first recognizer 132 may recognize physical boundaries around the host vehicle M and free space where the vehicle can travel based on outputs of the detection device, and the second recognizer 134 may recognize physical boundaries, free space, and gradient information around the host vehicle M from map information based on position information of the host vehicle M.

The determiner 142, for example, determines whether or not the camera lane markings recognized by the first recognizer 132 and the map lane markings recognized by the second recognizer 134 match. In addition, when it is determined that the camera lane markings and the map lane markings do not match, the determiner 142 performs various processes that enable the selector 144 to select either one of the first lane markings and the second lane markings by a plurality of determination processes described later (for example, first determination process to fourth determination process).

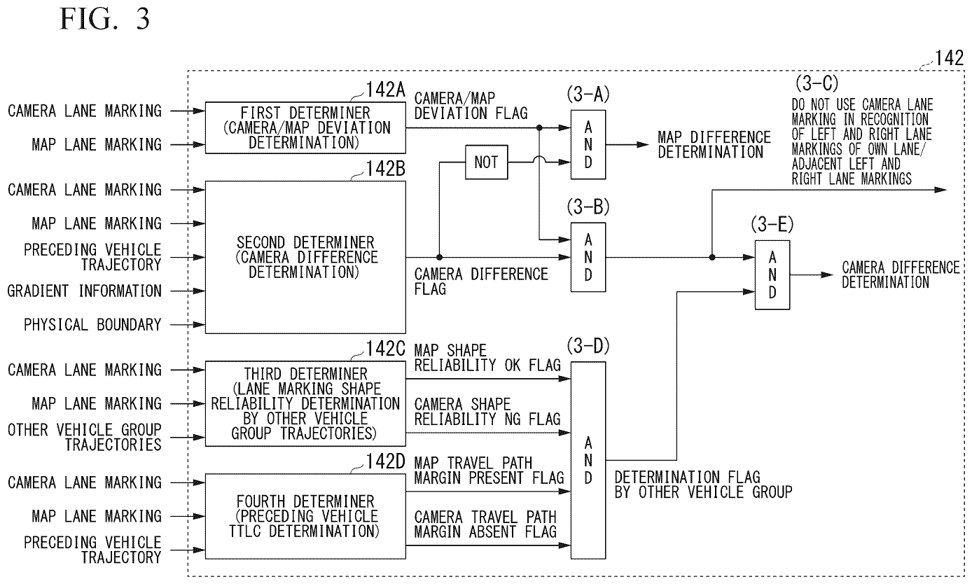

FIG. 3 is a diagram showing an example of determination processing executed by the determiner 142. In the example of FIG. 3, the determiner 142 includes, for example, a first determiner 142A, a second determiner 142B, a third determiner 142C, and a fourth determiner 142D. The third determiner 142C is an example of a “reliability determiner”. The fourth determiner 142D is an example of a “margin determiner”.

The first determiner 142A, as a first determination process, for example, inputs the camera lane markings recognized by the first recognizer 132 and the map lane markings recognized by the second recognizer 134, and performs a deviation determination between the camera lane markings and the map lane markings based on predetermined conditions (camera/map deviation determination).

The second determiner 142B, as a second determination process, for example, inputs the camera lane markings, the map lane markings, the travel trajectory of a preceding vehicle (preceding vehicle trajectory), road gradient information, and physical boundary information, and determines whether or not the recognition of the camera lane markings is different from the actual position of the lane markings based on predetermined conditions (camera difference determination).

The third determiner 142C, as a third determination process, for example, inputs the camera lane markings, the map lane markings, and travel trajectories of a predetermined number or more of other vehicle group around the host vehicle M (other vehicle group trajectories), and determines the reliability of lane marking shapes (camera lane marking shapes, map lane marking shapes) based on the other vehicle group trajectories based on predetermined conditions.

The fourth determiner 142D, as a fourth determination process, for example, inputs the camera lane markings, the map lane markings, and the preceding vehicle trajectory, and determines the presence or absence of margin in a travel path based on camera lane markings (camera travel path) and a travel path based on map lane markings (map travel path) from the margin of the travel path (for example, interference margin time TTLC (Time to Line Crossing) described later) using each lane marking and the preceding vehicle trajectory based on predetermined conditions (preceding vehicle TTLC determination). Details of each of the first to fourth determination processes described above will be described below.

### First Determination Process

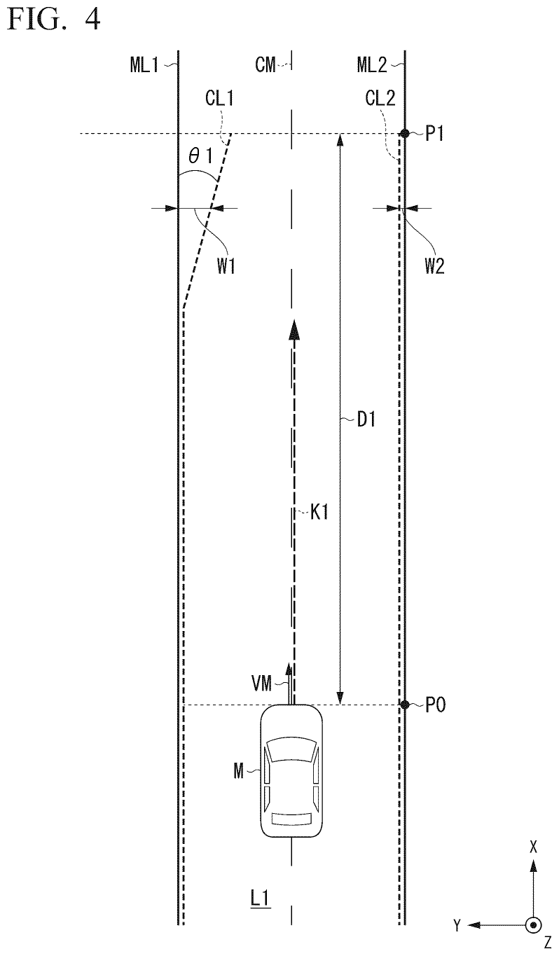

FIG. 4 is a diagram for explaining details of the first determination process. In the example of FIG. 4, camera lane markings CL1 and CL2 recognized by an image captured by the camera 10 (hereinafter, camera image) and map lane markings ML1 and ML2 obtained from map information (for example, first map information 54, second map information 62) based on position information of the host vehicle M are shown. Lane L1 is, for example, demarcated by map lane markings ML1 and ML2. Lane L1 shown in FIG. 4 is a lane that allows proceeding in the extending direction (X-axis direction in the figure). Hereinafter, when camera lane markings CL1 and CL2 are not distinguished from each other, they may be simply referred to as “camera lane markings CL”, and when map lane markings ML1 and ML2 are not distinguished from each other, they may be simply referred to as “map lane markings ML”. In addition, in the scene shown in FIG. 4, the host vehicle M is traveling on lane L1 at speed VM. In addition, as necessary, lane L1 on which the host vehicle M travels may be referred to as “travel lane L1”.

In addition, in the example of FIG. 4, the host vehicle M may be, for example, executing LKAS control. During LKAS execution, a target trajectory K1 is generated so that the host vehicle M does not deviate from lane L1 (in other words, so that the host vehicle M travels in the center of lane L1), and travel control that controls at least one of steering and speed of the host vehicle M is executed so that the host vehicle M travels along the generated target trajectory K1. In this travel control, feedforward control and feedback control are performed at any time based on the target trajectory K1 and the position of the host vehicle M to adjust the steering angle and speed of the host vehicle M.

The first recognizer 132, for example, recognizes surrounding situations including camera lane markings (first lane markings) CL that demarcate lanes existing around the host vehicle M including the traveling direction based on camera images captured by the camera 10 included in the detection device DD. For example, the first recognizer 132 performs known analysis processing (for example, edge extraction, feature extraction such as color, shape, and size, pattern matching processing, character recognition processing, etc.) on camera images, and recognizes camera lane markings CL on which the host vehicle M travels from the image analysis results. When recognizing camera lane markings CL, the first recognizer 132 extracts edge points where the luminance difference with adjacent pixels in the camera image is large, and connects the edge points to recognize camera lane markings CL in the image plane. In addition, the first recognizer 132 converts the position of the camera lane marking CL based on the position of a representative point of the host vehicle M into vehicle coordinates (for example, XY plane coordinates when the front direction of the host vehicle M is the X axis and the vehicle width direction (lateral direction) is the Y axis as shown in FIG. 4).

In the example of FIG. 4, the first recognizer 132 recognizes camera lane markings CL1 and CL2 based on camera images. Note that in the example of FIG. 4, camera lane markings CL1 and CL2 existing within a predetermined distance ahead (in the traveling direction) of the host vehicle M are shown, but camera lane markings on the sides and rear of the host vehicle M may also be recognized. In addition, the first recognizer 132 may recognize the curvature of lane L1 based on camera images, and may recognize the amount of curvature change of camera lane markings CL1 and CL2. The amount of curvature change is, for example, the time rate of change of curvature at x [m] ahead of the host vehicle M of camera lane markings CL1 and CL2 recognized by the camera 10.

In addition, the first recognizer 132 may recognize targets (camera targets) existing around the host vehicle M (within a predetermined distance) by the above-described analysis processing on camera images. Targets include, for example, physical boundaries such as fences and guardrails provided at positions where the host vehicle M can normally move (travel) without interfering (contacting), stationary targets such as parked vehicles, and moving targets such as other vehicles traveling. In addition, the first recognizer 132 may correct the position, shape, and the like of camera lane markings CL and targets based on information detected by the radar device 12 or LIDAR 14.

The second recognizer 134 recognizes map lane markings ML that demarcate the travel lane of the host vehicle M from map information based on position information of the host vehicle M. For example, the second recognizer 134 refers to map information (first map information 54, second map information 62) based on position information of the host vehicle M acquired by the vehicle sensor 40 or GNSS receiver 51, and recognizes map lane markings ML that demarcate lane L1 existing around the host vehicle M including the traveling direction from the map information.

In the example of FIG. 4, the second recognizer 134 recognizes map lane markings ML1 and ML2 based on map information. In addition, the second recognizer 134 may recognize the curvature and gradient of lane L1 from the map information, and may recognize the amount of curvature change of map lane markings ML1 and ML2.

The first determiner 142A, for example, determines whether or not the camera lane marking CL recognized by the first recognizer 132 and the map lane marking ML recognized by the second recognizer 134 deviate. For example, the first determiner 142A determines whether or not the camera lane marking CL1 that demarcates the left side of the travel lane L1 as viewed from the host vehicle M and the map lane marking ML1 deviate in a section from the current position of the host vehicle M (point P0 in the figure) to a position (point P1 in the figure) separated by a distance D1 in the traveling direction (ahead), and also determines whether or not the camera lane marking CL2 that demarcates the right side of the travel lane L1 and the map lane marking ML2 deviate. Here, the distance D1 is, for example, the distance to the farthest point of the camera lane markings CL1 and CL2 recognized (or where the recognition accuracy falls below a threshold) from the camera image by the first recognizer 132. In addition, the distance D1 may be a distance that changes according to the road shape or the speed VM of the host vehicle M, or may be a predetermined fixed distance. The range from the position of the host vehicle M (point P0) to point P1 separated by distance D1 is an example of an effective range (recognition effective range) in which camera lane markings CL can be recognized by the first recognizer 132.

For example, the first determiner 142A compares at least one of the extending direction (angle), position, curvature, and amount of curvature change of the camera lane marking CL1 and the map lane marking ML1, with the recognition effective range based on the distance D1 as the determination target range. For example, the first determiner 142A superimposes the camera lane marking CL1 and the map lane marking ML1 on a plane (XY plane) of the vehicle coordinate system with the position of a representative point of the host vehicle M as a reference, compares the respective extending directions of the camera lane marking CL1 and the map lane marking ML1 to acquire a deviation angle (yaw angle difference) θ1 of the lane markings, and when all of the following conditions are satisfied: the average value of the deviation angle θ1 in the determination target range is equal to or greater than a first threshold (condition 1a), the total value of the deviation angle θ1 in the determination target range is equal to or greater than a second threshold (condition 1b), the number of points where the deviation angle θ1 is equal to or greater than a third threshold is equal to or greater than a certain number (condition 1c), and the camera lane marking CL1 deviates to the inside of lane L1 from the map lane marking ML1 (condition 1d), it is determined that the camera lane marking CL1 and the map lane marking ML1 deviate (or do not match). Note that in condition 1c, the number of points where the deviation angle θ1 is equal to or greater than the third threshold is, for example, the number of points among those points where the deviation angle θ1 is equal to or greater than the third threshold since the camera lane marking CL1 and the map lane marking ML1 are more strictly composed of point clouds rather than lines, and there is a deviation angle for each point. In addition, when all of the above conditions 1a to 1d are not satisfied, the first determiner 142A determines that the camera lane marking CL1 and the map lane marking ML1 do not deviate (or match).

Note that the first determiner 142A may compare the lateral positions (in the lane width direction, Y-axis direction in the figure) of the camera lane marking CL1 and the map lane marking ML1 instead of (or in addition to) the above-described determination conditions, and determine that the camera lane marking CL1 and the map lane marking ML1 deviate when the deviation amount W1 is equal to or greater than a predetermined distance, or may compare the curvature or amount of curvature change of the camera lane marking CL1 and the map lane marking ML1, and determine that the camera lane marking CL1 and the map lane marking ML1 deviate when the degree of difference (magnitude) is equal to or greater than a predetermined value.

In addition, the first determiner 142A determines whether or not the right-side camera lane marking CL2 and the map lane marking ML2 in the determination target range deviate in the same manner as the comparison of the left-side lane markings. In addition, the first determiner 142A may comprehensively judge the comparison result of the left-side lane markings and the comparison result of the right-side lane markings to determine whether or not the camera lane marking CL and the map lane marking ML deviate. When the first determiner 142A determines that the camera lane marking CL and the map lane marking ML deviate, it outputs “1” as a camera/map deviation flag, and when it determines that they do not deviate, it outputs “0” as a camera/map deviation flag. Note that the determiner 142 may determine, for example, whether or not the camera lane marking CL and the map lane marking ML match using only the determination result of the first determiner 142A.

### Second Determination Process

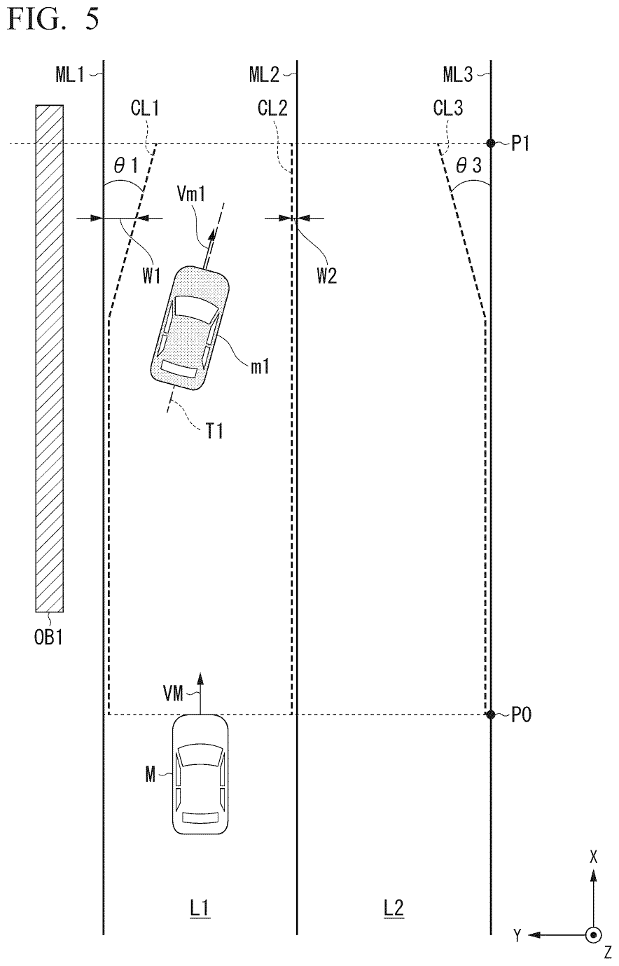

FIG. 5 is a diagram for explaining details of the second determination process. In the example of FIG. 5, on the right side of lane L1, there is an adjacent lane L2 demarcated by left and right camera lane markings CL2 and CL3 or map lane markings ML2 and ML3 compared to FIG. 4. In the example of FIG. 5, a deviation angle θ3 between camera lane marking CL3 and map lane marking ML3 is shown. In addition, in the example of FIG. 5, there is another vehicle m1 traveling at speed Vm1 ahead of the host vehicle M. The other vehicle m1 is an example of a “preceding vehicle”. In addition, in the example of FIG. 5, a physical boundary OB1 such as a guardrail exists on the left side of the map lane marking ML1 (or camera lane marking CL1) as viewed from the host vehicle M (on the right outer side of lane L1).

In the example of FIG. 5, the first recognizer 132 recognizes camera lane markings CL1, CL2, CL3, another vehicle m1, and physical boundary OB1, and recognizes their respective positions, shapes, and the like. In addition, the first recognizer 132 recognizes the speed Vm1 of the other vehicle m1 and recognizes the travel trajectory of the other vehicle M1. In addition, the second recognizer 134 recognizes map lane markings ML1, ML2, and ML3 based on map information. In addition, the second recognizer 134 may recognize gradient information of lanes L1 and L2 from the map information, and may recognize the physical boundary OB1.

The second determiner 142B performs camera difference determination based on the above-described recognition results. For example, the second determiner 142B, when it is determined to be a camera difference due to gradient information (condition 2a), when it is determined that the reliability of the camera shape (shape of camera lane marking CL) is absent by comparison with the preceding vehicle trajectory (condition 2b), when it is determined that the reliability of the camera shape is absent by comparison with the extending direction of the physical boundary OB1 (condition 2c), when the deviation of angles of the left and right camera lane markings CL is equal to or greater than a fourth threshold (condition 2d), and when it is determined that the deviation of angles of the left and right camera lane markings of lane L1 or L2 is equal to or greater than a fifth threshold (condition 2e), if any of these conditions is satisfied, outputs “1” as a camera difference flag indicating that the camera lane marking CL is different (erroneously recognized or incorrect). In addition, when none of the above-described conditions are met, it outputs “0” as a camera difference flag indicating that the camera lane marking CL is not different (not erroneously recognized or correct).

Note that in the determination of condition 2a, the second determiner 142B, for example, when it is determined by the first determiner 142A that the camera lane marking CL and the map lane marking ML deviate, and the road gradient of the travel lane L1 of the host vehicle M is equal to or greater than a predetermined value based on gradient information, determines that it is a camera difference due to gradient information, and when it is less than the predetermined value, determines that it is not a camera difference due to gradient information. In the determination of condition 2b, the second determiner 142B, for example, compares the deviation angle between the extending direction of the travel trajectory (preceding vehicle trajectory) T1 of the other vehicle m1 and the extending direction of the camera lane marking CL, and determines that the reliability of the camera shape (shape of camera lane marking CL) is absent when the deviation angle is equal to or greater than a predetermined angle. In the determination of condition 2c, the second determiner 142B, for example, compares the deviation angle between the extending direction of the physical boundary OB1 and the extending direction of the camera lane marking CL, and determines that the reliability of the camera shape (shape of camera lane marking CL) is absent when the deviation angle is equal to or greater than a predetermined angle.

In the determination of condition 2d, the second determiner 142B, for example, determines whether or not the deviation angle of the extending directions of the left and right camera lane markings CL1 and CL2 is equal to or greater than the fourth threshold. In the determination of condition 2e, the second determiner 142B, for example, determines whether or not the angle difference (deviation angle) of the left and right camera lane markings CL1 and CL2 in the travel lane L1 of the host vehicle M and the angle difference (deviation angle) of the left and right camera lane markings CL2 and CL3 in the adjacent lane L2 are equal to or greater than the fifth threshold.

As described above, the second determiner 142B determines whether or not the camera lane marking CL is erroneously recognized based on the preceding vehicle trajectory, physical boundary, and the like. This makes it possible to determine with higher accuracy that the camera lane marking is erroneously recognized.

### Third Determination Process

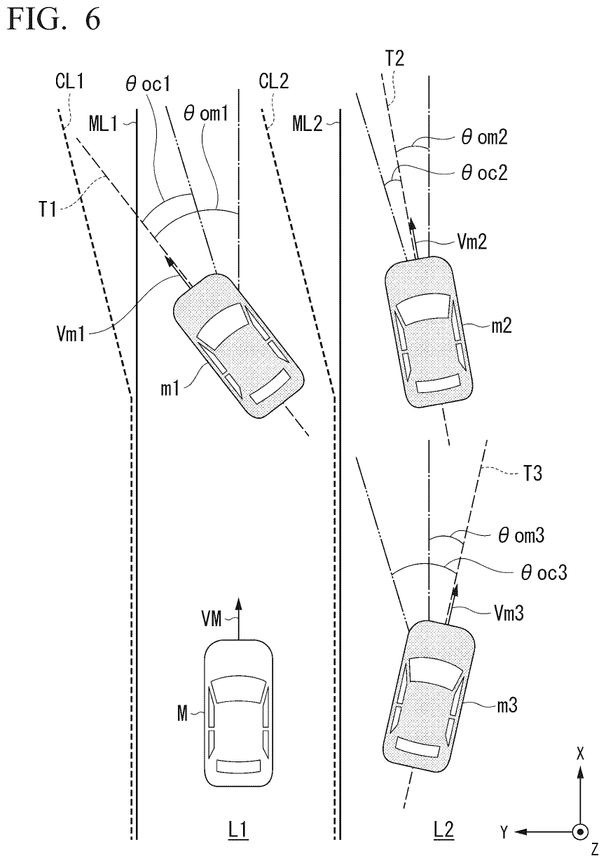

FIG. 6 is a diagram for explaining details of the third determination process. In the example of FIG. 6, the host vehicle M is traveling on lane L1 at speed VM, two other vehicles m1 and m2 exist ahead of the host vehicle M, and one other vehicle m3 exists on the side of the host vehicle M. The other vehicle m1 is a preceding vehicle traveling on the same lane L1 as the host vehicle M at speed Vm1. The other vehicle m2 is traveling on adjacent lane L2 adjacent to lane L1 at speed Vm2. The other vehicle m3 is on adjacent lane L2, exists in the lateral direction of the host vehicle M, and is a parallel-traveling vehicle traveling at speed Vm3.

When a predetermined number or more of other vehicles are recognized by the first recognizer 132, the third determiner 142C determines respective reliabilities of the camera lane marking CL and the map lane marking ML based on respective travel trajectories of the other vehicles (other vehicle group trajectories). The predetermined number may be a fixed number or a variable number based on road shape, type of road, and the like. Determining reliability means, for example, determining whether the reliability is correct (accurate) or incorrect (inaccurate). In addition, the third determiner 142C may determine whether the camera lane marking CL or the map lane marking ML is correctly recognized or is erroneously recognized. For example, when it is determined that the reliability is correct, the third determiner 142C determines that the lane marking is correctly recognized, and when it is determined that the reliability is incorrect, it determines that the lane marking is erroneously recognized.

Hereinafter, a specific example of the third determination process will be described. In the example of FIG. 6, while the host vehicle M is traveling on lane L1, the first recognizer 132 recognizes camera lane markings CL1 and CL2 and other vehicles m1, m2, and m3. In addition, the first recognizer 132 recognizes past and future travel trajectories T1, T2, and T3 for the other vehicles m1, m2, and m3 based on displacement (behavior) of positions of the other vehicles m1, m2, and m3 over a predetermined period. Travel trajectories T1 to T3 are an example of other vehicle group trajectories. In addition, the second recognizer 134 recognizes map lane markings ML1 and ML2. The third determiner 142C, for example, when it is determined by the first determiner 142A that there is a deviation between the camera lane marking CL and the map lane marking ML (for example, the camera/map deviation flag is “1”), determines whether or not a predetermined number (for example, 3 vehicles) or more of other vehicles exist within a predetermined distance from the host vehicle M. In the example of FIG. 6, it is assumed that it has been determined that a predetermined number or more of other vehicles exist within the predetermined distance. In this case, the third determiner 142C derives the degree of parallelism between these other vehicle group trajectories and the camera lane marking CL and the map lane marking ML.

For example, the third determiner 142C derives angles between the travel trajectories T1, T2, and T3 and the extending directions of the camera lane marking CL and the map lane marking ML. For example, in the example of FIG. 6, for convenience, the camera lane marking CL and the map lane marking ML are shown translated parallel to each of the other vehicles m1, m2, and m3. The camera lane marking CL for deriving the above angle may be an average of the shapes of the camera lane markings CL1 and CL2, or may be the camera lane marking closest to the target other vehicle. In addition, regarding the map lane marking ML for deriving the angle, similarly, it may be an average of the shapes of the map lane markings ML1 and ML2, or may be the map lane marking closest to the target other vehicle. The third determiner 142C derives an angle θoc1 between the travel trajectory T1 of the other vehicle m1 and the camera lane marking CL, and an angle θom1 between the travel trajectory T1 and the map lane marking ML. Similarly, the third determiner 142C calculates, for the other vehicle m2, an angle θoc2 between the travel trajectory T2 and the camera lane marking CL, and an angle θom2 between the travel trajectory T2 and the map lane marking ML. Similarly, the third determiner 142C derives, for the other vehicle m3, an angle θoc3 between the travel trajectory T3 and the camera lane marking CL, and an angle θom3 between the travel trajectory T3 and the map lane marking ML.

Next, the third determiner 142C calculates an average value of the respective derived angles. For example, the third determiner 142C calculates an average value (first average value) θocAve of angles between the travel trajectories T1, T2, and T3 of the other vehicles m1, m2, and m3 and the camera lane marking CL by “θocAve=(|θoc1|+|θoc2|+|θoc3|)/3”, and calculates an average value (second average value) θomAve between the other vehicle group trajectories and the map lane marking ML by “θomAve =(|θom1|+|θom2|+|θom3|)/3”.

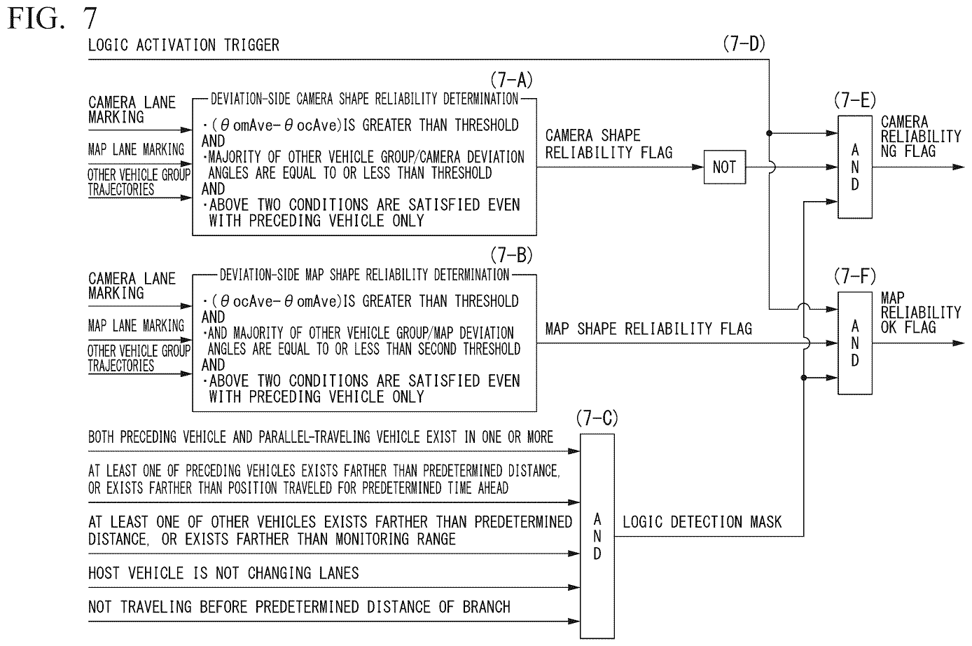

Next, the third determiner 142C performs determination using this information and the like. FIG. 7 is a diagram for explaining an example of determination content of the third determination process. For example, the third determiner 142C performs determination including a deviation-side camera shape reliability determination (FIG. 7-A), a deviation-side map shape reliability determination (FIG. 7-B), a determination regarding logic detection mask (FIG. 7-C), and a determination regarding logic activation trigger (FIG. 7-D).

In the deviation-side camera shape reliability determination (FIG. 7-A), the third determiner 142C, for example, when a value obtained by subtracting the first average value θocAve from the second average value θomAve (=θomAve-θocAve) is greater than a threshold (sixth threshold) (condition 3a), and a majority of angles θoc1, θoc2, and θoc3 between the travel trajectories T1, T2, and T3 of the other vehicles m1, m2, and m3 and the camera lane marking CL are equal to or less than a threshold (seventh threshold) (condition 3b), and furthermore when the above two conditions are satisfied even with only the preceding vehicle (condition 3c), outputs “1” to the camera shape reliability flag indicating that the camera lane marking CL is correct, and outputs “0” when all of the above conditions 3a to 3c are not satisfied.

In addition, in the deviation-side map shape reliability determination (FIG. 7-B), the third determiner 142C, for example, when a value obtained by subtracting the second average value θomAve from the first average value θocAve (=θocAve-θomAve) is greater than a threshold (eighth threshold) (condition 3d), and a majority of angles θom 1, θom2, and θom3 between the travel trajectories T1, T2, and T3 of the other vehicles m1, m2, and m3 and the map lane marking ML are equal to or less than a threshold (ninth threshold) (condition 3e), and furthermore when the above two conditions are satisfied even with only the preceding vehicle (condition 3f), outputs “1” to the map shape reliability flag indicating that the map lane marking ML is correct, and outputs “0” when all of the above conditions 3d to 3f are not satisfied.

In addition, in the determination regarding logic detection mask (FIG. 7-C), the third determiner 142C, for example, when both a preceding vehicle and a parallel-traveling vehicle exist in one or more vehicles among other vehicles existing around the host vehicle M (condition 3g), at least one of the preceding vehicles exists farther than a predetermined distance (first predetermined distance), or exists farther than a position traveled for a predetermined time ahead (condition 3h), at least one of the other vehicles exists farther than a predetermined distance (second predetermined distance), or exists farther than a monitoring range (condition 3i), the host vehicle M is not changing lanes (condition 3j), and the host vehicle M is not traveling before a predetermined distance (third predetermined distance) where the lane branches (condition 3k), outputs “1” as a logic detection mask when all the conditions are satisfied, and outputs “0” when the above conditions 3g to 3k are not satisfied. The first predetermined distance and the second predetermined distance are, for example, the recognition effective distance of the camera 10.

In addition, in the determination regarding logic activation trigger (FIG. 7-D), the third determiner 142C, for example, outputs “1” when it is determined that the camera difference flag is “1” (the camera lane marking CL is different) by comparison of gradient information, physical boundary, and preceding vehicle trajectory and camera lane marking CL in the second determination process in the second determiner 142B, and outputs “0” when the camera difference flag is “0”. That is, the logic activation trigger may be the same as the camera difference flag.

Then, based on the determination results of FIGS. 7-A to 7-D described above, the third determiner 142C, for example, when the camera shape reliability flag is “0”, the logic detection mask is “1”, and furthermore the logic activation trigger is “1”, outputs “1” to the camera reliability NG flag indicating that the reliability of the camera lane marking CL is incorrect (in other words, the camera lane marking CL is erroneously recognized), and outputs “0” indicating that the reliability of the camera lane marking CL is correct in other cases (FIG. 7-E).

In addition, when the map shape reliability flag is “1”, the logic detection mask is “1”, and furthermore the logic activation trigger is “1”, the third determiner 142C outputs “1” to the map reliability OK flag indicating that the reliability of the map lane marking ML is correct, and in other cases, outputs “0” indicating that the reliability of the map lane marking ML is incorrect (in other words, the map lane marking ML is erroneously recognized) (FIG. 7-F). Thus, according to the processing of the third determiner 142C, both information on whether the reliability of the camera lane marking CL is NG and information on whether the reliability of the map lane marking ML is OK can be output.

In addition, when it is determined that the reliability of the camera lane marking CL is incorrect and the reliability of the map lane marking ML is correct, the third determiner 142C may determine that selection of the map lane marking ML by the selector 144 is possible. The determination by the third determiner 142C can more clearly determine that the reliability of the camera lane marking CL is incorrect, and since the map lane marking ML is selected after clearly determining that the reliability of the map lane marking ML is correct, the map lane marking ML can be selected more appropriately than when the map lane marking ML is selected while the state of the camera lane marking CL remains unclear.

### Fourth Determination Process

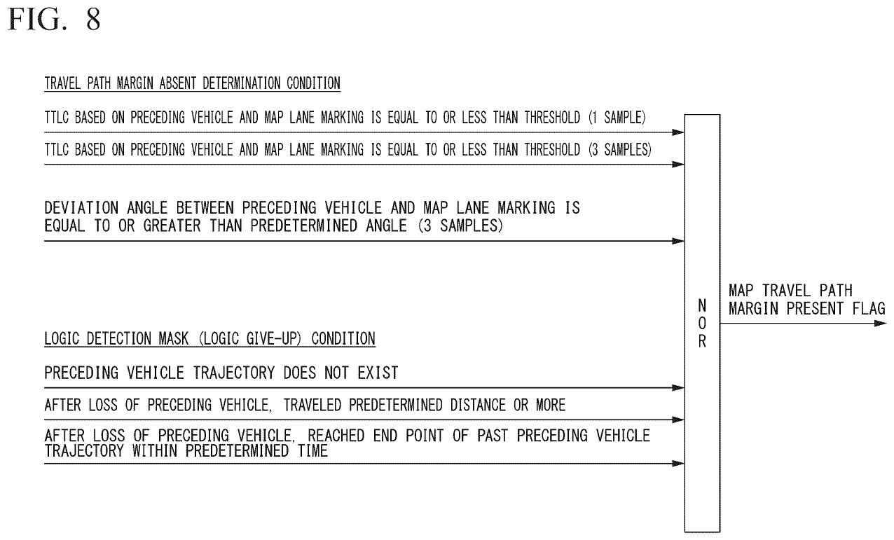

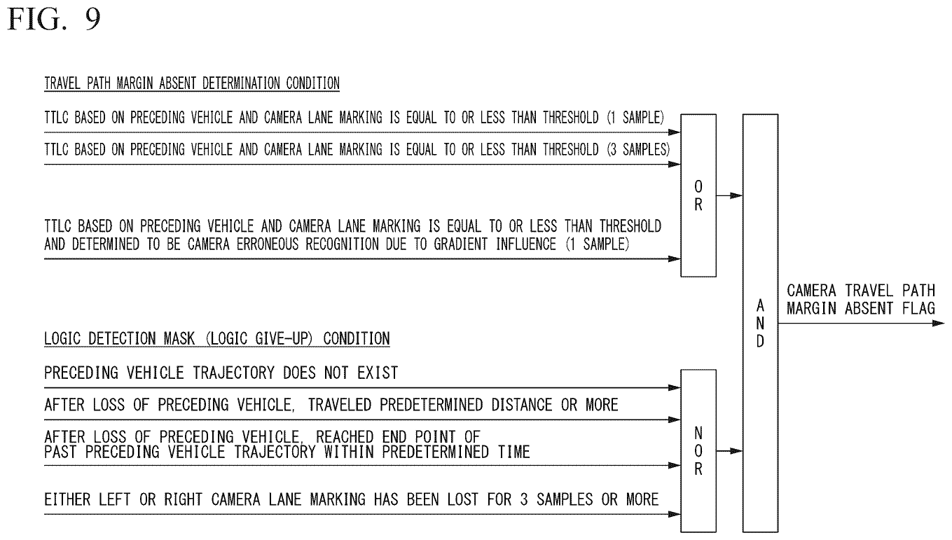

FIGS. 8 and 9 are diagrams (parts 1 and 2) for explaining details of the fourth determination process. The fourth determiner 142D, on the premise that a preceding vehicle trajectory is input, outputs a “map travel path margin present flag (FIG. 8)” and a “camera travel path margin absent flag (FIG. 9)” based on the determination conditions shown below. Conditions for outputting each flag include, for example, a travel path margin absent determination condition and a logic detection mask (logic give-up) condition.

### Map Travel Path Margin Present Flag

As shown in FIG. 8, the travel path margin absent determination condition for the map travel path margin present flag includes, for example, that the interference margin time TTLC based on the preceding vehicle and the map lane marking ML is equal to or less than a threshold (tenth threshold) in one sample (condition 4a), that the interference margin time TTLC based on the preceding vehicle and the map lane marking ML is equal to or less than a threshold (eleventh threshold) in three samples (condition 4b), and that the deviation angle between the preceding vehicle and the map lane marking ML is equal to or greater than a predetermined angle in three samples (condition 4c). One sample indicates one process among continuous processing at predetermined cycles, and three samples indicate three consecutive processes or three processes included within a predetermined time. Details of the derivation process of interference margin time TTLC will be described later.

In addition, the logic detection mask condition for the map travel path margin present flag includes, for example, that a trajectory of the preceding vehicle does not exist (condition 4d), that after loss of the preceding vehicle (after the preceding vehicle is no longer recognized by the first recognizer 132), the vehicle has traveled a predetermined distance (fourth predetermined distance) or more (condition 4e), and that after loss of the preceding vehicle, the end point of the past preceding vehicle trajectory is reached within a predetermined time (condition 4f).

The fourth determiner 142D, for example, when none of the above-described travel path margin absent determination conditions 4a to 4c and logic detection mask conditions 4d to 4f are applicable, outputs “1” to the map travel path margin present flag indicating that there is margin in the travel path of the map lane marking ML, and outputs “0” indicating that there is no margin when at least one condition is satisfied.

### Camera Travel Path Margin Absent Flag

As shown in FIG. 9, the travel path margin absent determination condition for the camera travel path margin absent flag includes, for example, that the interference margin time TTLC based on the preceding vehicle and the camera lane marking is equal to or less than a threshold (twelfth threshold) in one sample (condition 4g), that the interference margin time TTLC based on the preceding vehicle and the camera lane marking CL is equal to or less than a threshold (thirteenth threshold) in three samples (condition 4h), and that in one sample the interference margin time TTLC based on the preceding vehicle and the camera lane marking CL is equal to or less than a threshold (fourteenth threshold) and it is determined to be camera erroneous recognition due to gradient influence (condition 4i).

In addition, the logic detection mask condition for the camera travel path margin absent flag includes that a trajectory of the preceding vehicle does not exist (condition 4j), that after loss of the preceding vehicle, the vehicle has traveled a predetermined distance (fifth predetermined distance) or more (condition 4k), that after loss of the preceding vehicle, the end point of the past preceding vehicle trajectory is reached within a predetermined time (condition 4l), and that either left or right camera lane marking CL has been lost (not recognized) for three or more samples (condition 4m).

The fourth determiner 142D, for example, when any one of the above-described travel path margin absent determination conditions 4g to 4 i is satisfied and none of the logic detection mask conditions 4j to 4m are applicable, outputs “1” as a camera travel path margin absent flag indicating that there is no margin in the travel path of the camera lane marking CL, and in other cases outputs “0” indicating that there is margin.

Here, the derivation process of the interference margin time TTLC described above will be described. In the embodiment, the interference margin time TTLC is derived by each of the two derivation processes shown below, and the final interference margin time TTLC is derived by comparing the two derived interference margin times TTLC. The two derivation processes will be described below.

### First Derivation Process

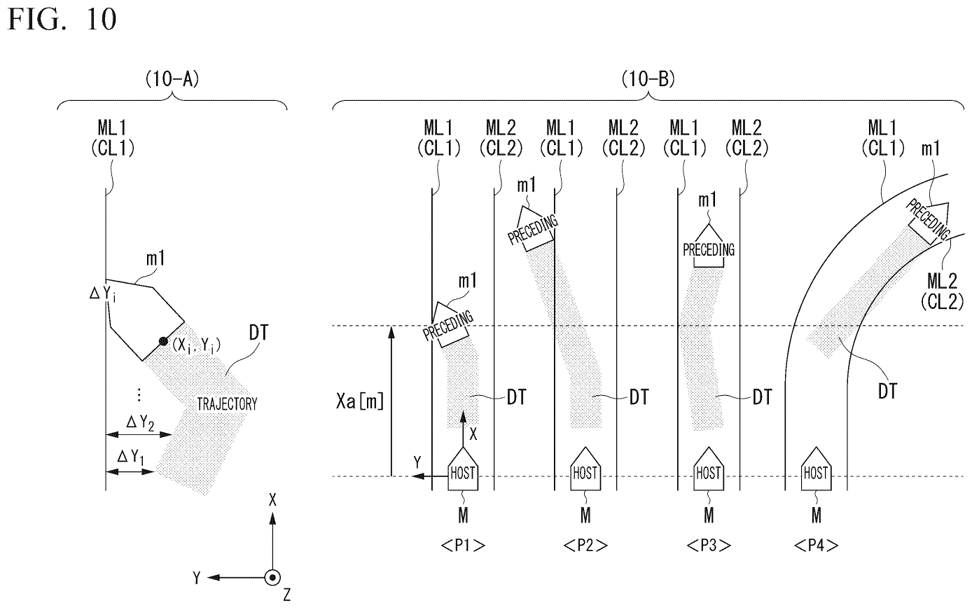

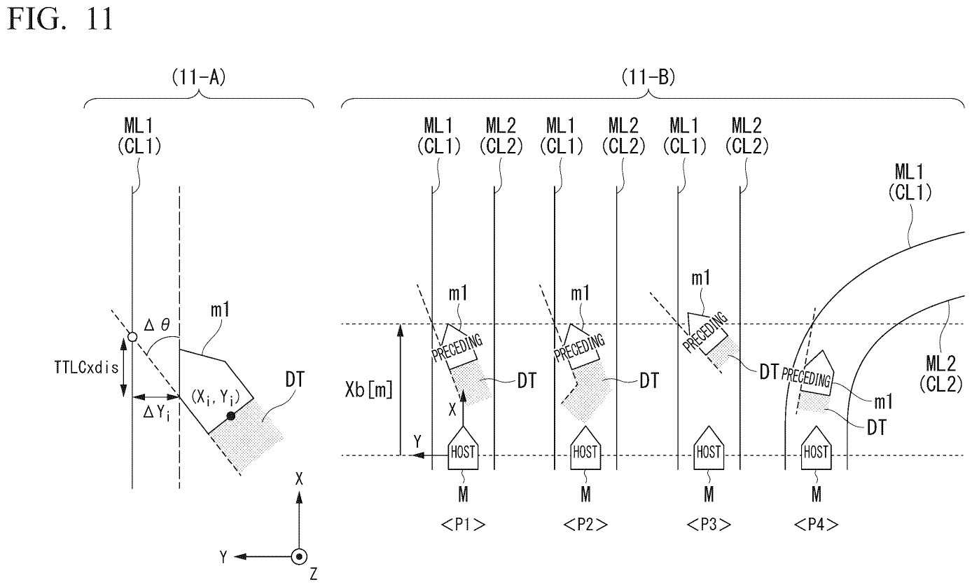

FIG. 10 is a diagram for explaining a first derivation process of interference margin time TTLC. FIGS. 10-A and 10-B show a preceding vehicle m1 traveling ahead of the host vehicle M and a travel trajectory DT based on the lateral width of the preceding vehicle in simplified form. This travel trajectory DT includes a travel trajectory when the preceding vehicle m1 travels straight in the current traveling direction. FIG. 10-A shows a state at the time when the preceding vehicle m1 (or travel trajectory DT) interferes with the left map lane marking ML1 of the travel lane. Interfering means, for example, as shown in FIG. 10-A, at least a part of the vehicle body contacts the lane marking when the XY plane is viewed from directly above. FIG. 10-B shows four patterns <P1> to <P4> as an example of the preceding vehicle m1 interfering with the map lane marking ML (ML1 or ML2). Note that in the case of the determination of the map travel path margin present flag described above, the map lane markings ML1 and ML2 are the targets, and in the case of the camera travel path margin absent flag, the camera lane markings CL1 and CL2 are the targets. In the following, a case where the map lane marking ML is targeted will be described. The same applies to FIG. 11 described later.

In the first derivation process, the fourth determiner 142D, for example, when the distance (distance in the X-axis direction) from the position of the host vehicle M until the preceding vehicle m1 contacts (interferes with) the map lane marking ML1 as shown in FIG. 10-A is Xa [m], derives the interference margin time TTLC1 (first margin) between the host vehicle M and the map lane marking ML1 by dividing the distance Xa by the speed VM of the host vehicle M (TTLC1=Xa/VM).

### Second Derivation Process

FIG. 11 is a diagram for explaining a second derivation process of interference margin time TTLC. FIGS. 11-A and 11-B show a preceding vehicle m1 traveling ahead of the host vehicle M and a travel trajectory DT of the preceding vehicle m1 in simplified form. In the second derivation process, the margin time until a preset position where it is determined that the preceding vehicle m1 has a possibility of interfering with the map lane marking ML (a position separated by a predetermined distance from the map lane marking ML) is derived. The above position may be a fixed position or a variable position based on the speed of the preceding vehicle m1, road shape, and the like. FIG. 11-B shows four patterns <P1> to <P4> as an example of the preceding vehicle m1 being at a preset position where it is determined that there is a possibility of contacting the map lane marking ML.

In the second derivation process, the fourth determiner 142D, for example, as shown in FIG. 11-A, derives the distance TTLCxdis in the X direction from the position of the preceding vehicle m1 where it is determined that there is a possibility of interfering with the map lane marking ML to the position where it interferes with the map lane marking ML1, by calculating “TTLCxdis=ΔYi/tan(Δθ)” using the lateral distance ΔYi from the map lane marking ML1 of the preceding vehicle m1 and the yaw angle Δθ of the preceding vehicle m1 with respect to the lane extending direction (X-axis direction). In addition, the distance Xb [m] from the host vehicle M to the position where it is determined that the preceding vehicle m1 has a possibility of contacting the map lane marking ML is derived, for example, by adding the position Xi of the preceding vehicle m1 when the reference position of the host vehicle M (for example, the center or center of gravity of the host vehicle M) is the origin ((X, Y)=(0, 0)) and the distance TTLCxdis (Xb=Xi+TTLCxdis). Then, the fourth determiner 142D derives the interference margin time TTLC2 (second margin) between the host vehicle M and the map lane marking ML1 by dividing the distance Xb, which is the distance from the position of the host vehicle M to the position where it is determined that the preceding vehicle m1 has a possibility of contacting the map lane marking ML, by the speed VM of the host vehicle M (TTLC2=Xb/VM).

The fourth determiner 142D compares the above-described interference margin times TTLC1 and TTLC2, and selects the interference margin time with the smaller value among the interference margin times TTLC1 and TTLC2 as the margin (interference margin time TTLC used in the travel path margin absent determination condition for the map travel path margin present flag) for the map lane marking ML. In addition, the fourth determiner 142D selects the interference margin time with the larger value among the interference margin times TTLC1 and TTLC2 as the margin (interference margin time TTLC used in the travel path margin absent determination condition for the camera travel path margin absent flag) for the camera lane marking CL. In this way, by obtaining and comparing a plurality of interference margin times TTLC in different processes, it is possible to more accurately determine that there is margin in traveling on the map lane marking ML. Therefore, the appropriateness when selecting the map lane marking ML can be improved. In addition, by deriving two margins as described above, for example, on a curved road, the second margin is initially calculated to be smaller for the lane marking on the outside of the turn, so the second margin is selected, and when traveling continues and the lane marking is actually stepped on, the first margin is adopted, enabling selection of margin according to the situation.

In addition, when it is determined that there is no margin in the travel path of the camera lane marking CL (when the camera travel path margin absent flag is “1”) and it is determined that there is margin in the travel path of the map lane marking ML (when the map travel path margin present flag is “1”), the fourth determiner 142D may determine that selection of the map lane marking ML by the selector 144 is possible. This makes it possible to select the map lane marking ML after clearly determining that there is no margin in the travel path of the camera lane marking CL and clearly determining that there is margin in the travel path of the map lane marking ML, so the map lane marking ML can be selected more appropriately than when the map lane marking ML is selected while the state of the camera lane marking remains unclear.

The first determination process, second determination process, third determination process, and fourth determination process described above may each be executed synchronously at predetermined cycles, or may be executed at different cycles or timings. The determiner 142 performs various determinations as shown in FIG. 3 based on determination results (results of the first to fourth determination processes) by the first determiner 142A, the second determiner 142B, the third determiner 142C, and the fourth determiner 142D described above, and outputs a final determination result.

Returning to FIG. 3, the determiner 142, for example, when the camera/map deviation flag determined by the first determiner 142A is “1” and the camera difference flag determined by the second determiner 142B is “0” (not a camera difference), determines that the map lane marking ML is different (incorrect) (map difference determination) (FIG. 3-A).

In addition, the determiner 142, for example, when the camera/map deviation flag determined by the first determiner 142A is “1” and the camera difference flag determined by the second determiner 142B is “1”, determines that the camera lane marking CL is different (incorrect) (camera difference determination) (FIG. 3-B). In addition, when it is determined that the camera lane marking CL is different, the determiner 142 may determine not to use the camera lane marking CL in recognition of the left and right lane markings of the travel lane (own lane) of the host vehicle M and the left and right lane markings of the adjacent lane (FIG. 3-C).

In addition, the determiner 142, for example, when the map shape reliability OK flag determined by the third determiner 142C is “1”, the camera shape reliability NG flag is “1”, the map travel path margin present flag determined by the fourth determiner 142D is “1”, and it is determined that the camera travel path margin absent flag is “1”, outputs “1” as a determination flag by other vehicle group, and in other cases outputs “0” (FIG. 3D). Then, when it is determined in FIG. 3-B that the camera lane marking CL is different (or the camera difference flag is “1”), and the determination flag in FIG. 3-D is “1”, the determiner 142 determines that the camera lane marking CL is different (more incorrect) (camera difference determination) (FIG. 3-E).

By performing the above-described determination, the determiner 142 can determine with higher accuracy that the camera lane marking CL is different or that the map lane marking ML is different based on the recognition situation around the host vehicle M including surrounding vehicles.

The selector 144 selects at least one lane marking for use in travel control of the host vehicle M from among the camera lane marking CL and the map lane marking ML based on the determination result by the determiner 142. For example, when it is determined by the determiner 142 that the camera lane marking CL and the map lane marking ML match (do not deviate), the selector 144 selects one predetermined or both lane markings among the camera lane marking CL and the map lane marking ML. In addition, when it is determined by the determiner 142 that the camera lane marking CL is different (in the case of camera difference determination), the selector 144 selects the map lane marking ML. In addition, when it is determined by the determiner 142 that the map lane marking ML is different (in the case of map difference determination), the selector 144 selects the camera lane marking CL. In addition, when it is determined not to use the camera lane marking CL in recognition of the left and right lane markings of the own lane and the left and right lane markings of the adjacent lane, the selector 144 selects the map lane marking ML. In addition, when it is determined by the third determiner 142C and the fourth determiner 142D that selection of the map lane marking ML is possible, the selector 144 may select the map lane marking ML. Note that the selector 144 does not need to select a lane marking when it is determined by the determiner 142 that the camera lane marking CL and the map lane marking ML do not match and predetermined conditions are satisfied.

The execution controller 146 executes control (travel control) of the host vehicle M based on recognition results of the first recognizer 132 and the second recognizer 134, determination results by the determiner 142, selection results by the selector 144, and the like. For example, the execution controller 146 determines travel control for the host vehicle M based on the above recognition results, determination results, selection results, and the like, and generates a target trajectory K1 based on the determined travel control. “Determining travel control” may include, for example, determining the content (type) of travel control and determining whether to execute (suppress) travel control. In addition, “executing travel control” may include, for example, in addition to switching and executing the content of travel control, continuing travel control already being executed. “Suppressing travel control” may include not only not executing travel control but also lowering the mode (automation level) of travel control.

Here, travel control includes a first travel mode and a second travel mode in which the degree of driving assistance is lower than the first travel mode or the task of occupants of the host vehicle M is greater than the first travel mode. A low degree of driving assistance means, for example, that the automation rate in travel control is small. A small automation rate means, for example, that the degree to which the automated driving control device 100 controls the steering or speed of the host vehicle M is low (the degree to which the driver needs to intervene in steering or acceleration/deceleration operations is high). A large occupant task means, for example, that the number of tasks imposed on occupants is large or the tasks are severe. Tasks include, for example, monitoring the surroundings of the host vehicle M, occupants operating the driving operator 80, and the like. Operation of the driving operator 80 includes, for example, a driver being in a state of gripping the steering wheel (hereinafter, hands-on state). Note that travel control may include a third travel mode in which the degree of driving assistance is lower than the second travel mode or the task of occupants of the host vehicle M is greater than the second travel mode. In addition, the travel mode with the lowest degree of driving assistance or the largest task of occupants of the host vehicle M may be a fully manual travel mode (mode in which travel control is not executed).

For example, the first travel mode has no occupant task (or is the lightest), and allows travel control (for example, LKAS, ACC, ALC, TJP, CMBS, etc.) in a state where occupants of the host vehicle M are not gripping the steering wheel (hereinafter, hands-off state). In addition, in the second travel mode, tasks imposed on occupants may include, for example, monitoring the surroundings of the host vehicle M and being in a hands-on state.

For example, the execution controller 146, for example, during execution of the first travel mode (for example, travel control in a hands-off state), when it is determined that the camera lane marking CL and the map lane marking ML match, continues the first travel mode. For example, when the execution controller 146 is executing LKAS that travels in the center of the travel lane L1 as the first travel mode, it generates a target trajectory (for example, target trajectory K1 shown in FIG. 4) for traveling in the center of lane L1 based on one or both of the camera lane marking CL and the map lane marking ML selected by the selector 144, and executes control by the second controller 160 to travel along the generated target trajectory K1. For example, when either one of the camera lane marking CL and the map lane marking ML is selected by the selector 144, the execution controller 146 generates the target trajectory K1 based on the left and right positions of the selected one lane marking. In addition, when information on the center line of lane L1 is acquired from map information, the execution controller 146 generates the target trajectory K1 so that a representative point (for example, center of gravity or center) of the host vehicle M passes on that center line. In addition, when both the camera lane marking CL and the map lane marking ML are selected by the selector 144, the execution controller 146 may move (correct) the position of the other lane marking (for example, map lane marking ML) to match the position of one lane marking (for example, camera lane marking CL), and generate the target trajectory K1 using information on the moved lane marking.

In addition, the execution controller 146, during execution of the second travel mode (for example, driving in a hands-on state), when it is determined that the camera lane marking CL and the map lane marking ML match in the determination target range, may perform control to switch from the second travel mode to the first travel mode. In this case, when performing switching control, the execution controller 146 may cause the HMI 30 to output information indicating that switching is possible or information inquiring whether to switch (or information proposing switching) to occupants, and perform switching of travel mode when information indicating permission to switch is accepted from occupants. In addition, the execution controller 146 may switch from the second travel mode to the first travel mode at a timing when it is determined that the camera lane marking CL and the map lane marking ML match after there is an instruction to switch to the first travel mode by the HMI 30.

In addition, the execution controller 146 may suppress travel control by the first travel mode when it is determined that the camera lane marking CL and the map lane marking ML in the determination target range do not match and a lane marking is not selected by the selector 144. For example, during execution of the first travel mode, when it is determined that the camera lane marking CL and the map lane marking ML do not match, the execution controller 146 executes travel control to switch from the first travel mode to the second travel mode. In this case, the HMI controller 180, for example, causes the HMI 30 to output information (handover request) that prompts occupants to manually drive in order to switch to the second travel mode (for example, switch from automated driving to manual driving). In addition, the execution controller 146, during execution of the second travel mode, when it is determined that the camera lane marking CL and the map lane marking ML do not match and a lane marking is not selected by the selector 144, may control so that switching to the first travel mode cannot be executed.

In addition, the execution controller 146, during execution of the first travel mode, when it is determined that the camera lane marking CL and the map lane marking ML in the determination target range do not match and either one lane marking of the camera lane marking CL and the map lane marking ML is selected by the selector 144, continues the first travel mode based on the selected lane marking. In addition, the execution controller 146, during execution of the second travel mode, when the above conditions are satisfied, may perform control to switch from the second travel mode to the first travel mode based on either one lane marking of the camera lane marking CL and the map lane marking ML selected by the selector 144.

### Modified Example

In the embodiment described above, the determination conditions in each of the first determination process to fourth determination process described above may be changed to other conditions, other conditions may be added, or some of the conditions may be deleted. In addition, in the embodiment, the determiner 142 may determine whether to select the map lane marking ML from only the results of the third determiner 142C and the fourth determiner 142D.

### Processing Flow

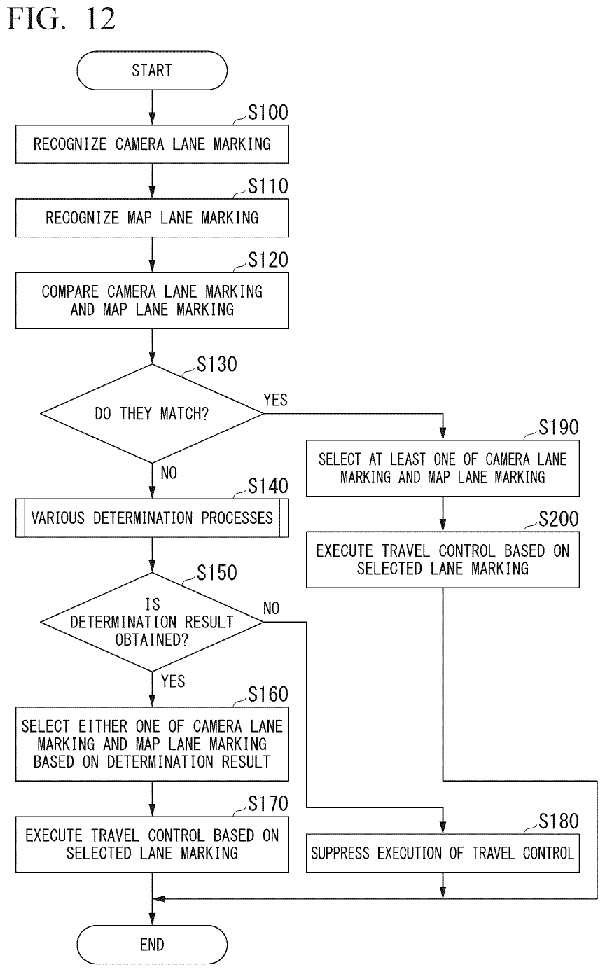

Hereinafter, processing executed by the automated driving control device 100 of the embodiment will be described. FIG. 12 is a flowchart showing an example of a flow of processing executed by the automated driving control device 100. Note that in the following, among processing executed by the automated driving control device 100, mainly driving control processing based on the recognition situation of lane markings and the like will be described as the center. The processing shown below may be repeatedly executed at predetermined timings or predetermined cycles, and may be repeatedly executed while driving control by the automated driving control device 100 is being executed.

In the example of FIG. 12, the first recognizer 132 recognizes camera lane markings CL existing around the host vehicle M based on camera images captured by the camera 10 (step S100). Next, the second recognizer 134 refers to map information based on position information of the host vehicle M and recognizes map lane markings ML existing around the host vehicle M from the map information (step S110). Note that each process of steps S100 and S110 may be executed in an order different from the order described above.

Next, the determiner 142 compares the camera lane marking CL and the map lane marking ML (step S120), and determines whether or not the camera lane marking CL and the map lane marking ML match (step S130). When it is determined that the camera lane marking CL and the map lane marking ML do not match, the determiner 142 performs various determination processes including the first determination process to fourth determination process described above (step S140). Next, the determiner 142 determines whether or not a determination result has been obtained (step S150). When it is determined that a determination result has been obtained, either one of the camera lane marking CL and the map lane marking ML is selected based on the determination result (step S160).

Next, the execution controller 146 generates a target trajectory based on the selected lane marking, and causes the second controller 160 to execute (continue if being executed) travel control (for example, travel control by the first travel mode) based on the generated target trajectory (step S170). In addition, in the process of step S150, when it is determined that a determination result has not been obtained, the selector 144 does not select a lane marking, and the execution controller 146 suppresses execution of travel control (step S180).

In addition, in the process of step S130, when it is determined that the camera lane marking CL and the map lane marking ML match, the selector 144 selects at least one of the camera lane marking CL and the map lane marking ML (step S190). Next, the execution controller 146 generates a target trajectory based on the selected lane marking, and causes the second controller 160 to execute travel control based on the generated target trajectory (step S200). This completes the processing of this flowchart.

Note that in the processing of steps S120 to S140, first the first determination process by the first determiner 142A may determine whether the camera lane marking CL and the map lane marking ML match (deviate), and when it is determined that they do not match, the second to fourth determination processes may be performed. In addition, in the process of step S150, when it is determined that a determination result has not been obtained, the camera lane marking CL and the map lane marking ML may be compared, and when the degree of deviation (for example, magnitude of deviation angle) is equal to or greater than a threshold, the camera lane marking CL may be selected and the process may proceed to step S170, and when it is less than the threshold, the process may proceed to step S190.

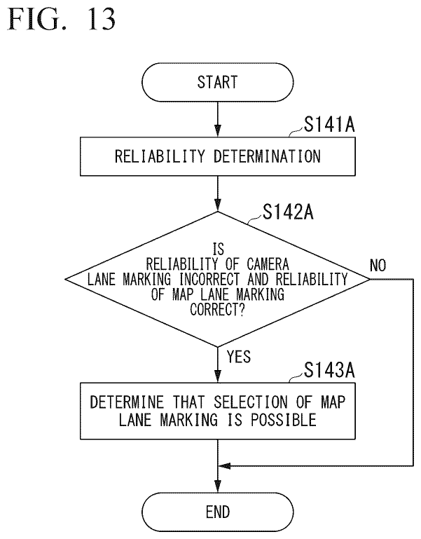

FIG. 13 is a flowchart showing an example of various determination processes in step S140. In the example of FIG. 13, processing corresponding to the third determination process is shown. In the example of FIG. 13, the determiner 142 (third determiner 142C), for example, determines respective reliabilities of the camera lane marking CL and the map lane marking ML based on travel trajectories of other vehicles around the host vehicle M (step S141A). Next, the determiner 142 determines whether, based on the determination result, the reliability of the camera lane marking is incorrect and the reliability of the map lane marking is correct (step S142A). When the above determination condition is satisfied, the determiner 142 determines that determination of the map lane marking is possible (step S143A). This completes the processing of this flowchart.

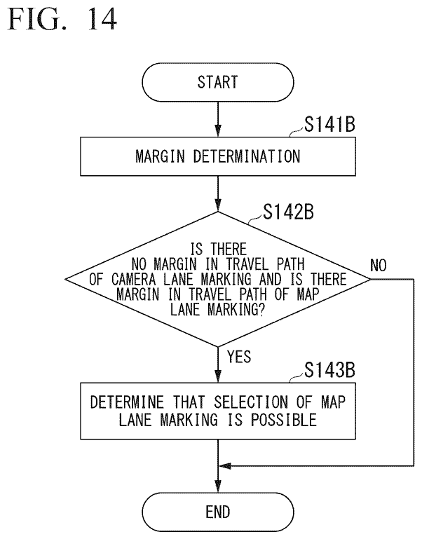

FIG. 14 is a flowchart showing another example of various determination processes in step S140. In the example of FIG. 14, processing corresponding to the fourth determination process is shown. In the example of FIG. 14, the determiner 142 (fourth determiner 142D), for example, determines a margin until a preceding vehicle interferes with the camera lane marking CL and the map lane marking ML based on a travel trajectory of a preceding vehicle of the host vehicle M (step S141B). Next, the determiner 142 determines whether, based on the determination result, there is no margin in the travel path of the camera lane marking CL and there is margin in the travel path of the map lane marking (step S142B). When the above determination condition is satisfied, the determiner 142 determines that determination of the map lane marking is possible (step S143B). This completes the processing of this flowchart. Note that the processing content in step S140 is not limited to the processing of FIGS. 13 and 14 described above, and may include the first determination process, second determination process, or other determination processes.

According to the embodiment described above, the automated driving control device 100 (an example of a travel control device) comprises: the first recognizer 132 that recognizes surrounding situations including camera lane markings CL (an example of first lane markings) that demarcate lanes around the host vehicle M based on outputs of detection device DD that has detected the surrounding situation of the host vehicle M, the second recognizer 134 that recognizes map lane markings ML (an example of second lane markings) that demarcate lanes around the host vehicle M from map information based on position information of the host vehicle M, the determiner 142 that determines whether or not the camera lane markings CL and the map lane markings ML match, the selector 144 that selects either one lane marking among the camera lane markings CL and the map lane markings ML when it is determined by the determiner 142 that the camera lane markings CL and the map lane markings ML do not match, and a travel controller (execution controller 146, second controller 160) that executes travel control of the host vehicle M based on the lane marking selected by the selector 144, wherein the determiner 142 comprises: a reliability determiner (third determiner) that determines respective reliabilities of the camera lane markings CL and the map lane markings ML based on travel trajectories of other vehicles when a predetermined number or more of other vehicles are recognized by the first recognizer 132; and a margin determiner (fourth determiner) that determines a margin until a preceding vehicle interferes with the camera lane markings CL and the map lane markings ML based on a travel trajectory of the preceding vehicle when a preceding vehicle traveling ahead of the host vehicle M is recognized by the first recognizer 132, and the selector 144 determines whether or not to select the map lane markings ML based on the reliability and the margin, whereby more appropriate travel control can be executed based on the recognition situation of the vehicle surroundings. Furthermore, it can contribute to the development of sustainable transportation systems.

For example, according to the embodiment, for example, when the camera lane marking CL and the map lane marking ML do not match, the appropriateness of traveling using the map lane marking can be more appropriately judged based on results of lane marking difference determination by preceding vehicle trajectory and physical boundary, lane marking reliability determination by other vehicle group, and travel path margin determination by interference margin time TTLC using a preceding vehicle. Therefore, for example, even when the camera lane marking CL and the map lane marking ML do not match while the host vehicle M is executing the first travel mode (hands-off state), travel control such as the first driving mode can be executed (continued if being executed) based on the selected lane marking, so output of manual driving requests and the like can be suppressed, and the continuity of travel control can be further improved.

The embodiment described above can be expressed as follows.

A travel control device comprising:
a storage medium storing computer-readable instructions; and
a processor connected to the storage medium,
the processor executing the computer-readable instructions to:
recognize surrounding situations including a first lane marking that demarcates a lane around a host vehicle based on an output of a detection device that has detected the surrounding situation of the host vehicle;
recognize a second lane marking that demarcates a lane around the host vehicle from map information based on position information of the host vehicle;
determine whether or not the first lane marking and the second lane marking match;
select either one lane marking among the first lane marking and the second lane marking when it is determined that the first lane marking and the second lane marking do not match;
execute travel control of the host vehicle based on the selected lane marking;
determine respective reliabilities of the first lane marking and the second lane marking based on travel trajectories of other vehicles when a predetermined number or more of other vehicles are recognized;
determine a margin until a preceding vehicle interferes with the first lane marking and the second lane marking based on a travel trajectory of the preceding vehicle when a preceding vehicle traveling ahead of the host vehicle is recognized; and
determine whether or not to select the second lane marking based on the reliability and the margin.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A travel control device comprising:
a first recognizer that recognizes surrounding situations including a first lane marking that demarcates a lane around a host vehicle based on an output of a detection device that has detected the surrounding situation of the host vehicle;
a second recognizer that recognizes a second lane marking that demarcates a lane around the host vehicle from map information based on position information of the host vehicle;
a determiner that determines whether or not the first lane marking and the second lane marking match;
a selector that selects either one lane marking among the first lane marking and the second lane marking when the determiner determines that the first lane marking and the second lane marking do not match; and
a travel controller that executes travel control of the host vehicle based on the lane marking selected by the selector,
wherein the determiner comprises:
a reliability determiner that determines respective reliabilities of the first lane marking and the second lane marking based on travel trajectories of the other vehicles when a predetermined number or more of other vehicles are recognized by the first recognizer; and
a margin determiner that determines a margin until the preceding vehicle interferes with the first lane marking and the second lane marking based on a travel trajectory of the preceding vehicle when a preceding vehicle traveling ahead of the host vehicle is recognized by the first recognizer, and
the selector determines whether or not to select the second lane marking based on the reliability and the margin.

2. The travel control device according to claim 1, wherein
the reliability determiner determines that selection of the second lane marking is possible when the reliability of the first lane marking is determined to be incorrect and the reliability of the second lane marking is determined to be correct.

3. The travel control device according to claim 1, wherein
the margin determiner determines that selection of the second lane marking is possible when the margin of a travel path of the first lane marking is determined to be absent and the margin of a travel path of the second lane marking is determined to be present.

4. The travel control device according to claim 3, wherein
the margin determiner performs a first derivation process of deriving a first margin based on a position when the preceding vehicle travels straight in the current traveling direction and interferes with the first lane marking and the second lane marking, and a second derivation process of deriving a second margin based on a preset position where the preceding vehicle is determined to have a possibility of interfering with the first lane marking and the second lane marking, and
determines the margin based on respective processing results of the first derivation process and the second derivation process.

5. The travel control device according to claim 4, wherein
the margin determiner:
selects, as the margin for the second lane marking, the margin with the smaller value among the first margin and the second margin; and
selects, as the margin for the first lane marking, the margin with the larger value among the first margin and the second margin.

6. The travel control device according to claim 1, wherein
the first recognizer recognizes the preceding vehicle and also recognizes a physical boundary provided at a position where the host vehicle can move without interfering, and
the determiner determines whether or not the first lane marking is erroneously recognized based on the travel trajectory of the preceding vehicle and the physical boundary.

7. A travel control method in which a computer:
recognizes surrounding situations including a first lane marking that demarcates a lane around a host vehicle based on an output of a detection device that has detected the surrounding situation of the host vehicle;
recognizes a second lane marking that demarcates a lane around the host vehicle from map information based on position information of the host vehicle;
determines whether or not the first lane marking and the second lane marking match;
selects either one lane marking among the first lane marking and the second lane marking when it is determined that the first lane marking and the second lane marking do not match;
executes travel control of the host vehicle based on the selected lane marking;
determines respective reliabilities of the first lane marking and the second lane marking based on travel trajectories of other vehicles when a predetermined number or more of other vehicles are recognized;
determines a margin until a preceding vehicle interferes with the first lane marking and the second lane marking based on a travel trajectory of the preceding vehicle when a preceding vehicle traveling ahead of the host vehicle is recognized; and
determines whether or not to select the second lane marking based on the reliability and the margin.

8. A computer-readable non-transitory storage medium storing a program that causes a computer to:
recognize surrounding situations including a first lane marking that demarcates a lane around a host vehicle based on an output of a detection device that has detected the surrounding situation of the host vehicle;
recognize a second lane marking that demarcates a lane around the host vehicle from map information based on position information of the host vehicle;
determine whether or not the first lane marking and the second lane marking match;
select either one lane marking among the first lane marking and the second lane marking when it is determined that the first lane marking and the second lane marking do not match;
execute travel control of the host vehicle based on the selected lane marking;
determine respective reliabilities of the first lane marking and the second lane marking based on travel trajectories of other vehicles when a predetermined number or more of other vehicles are recognized;
determine a margin until a preceding vehicle interferes with the first lane marking and the second lane marking based on a travel trajectory of the preceding vehicle when a preceding vehicle traveling ahead of the host vehicle is recognized; and
determine whether or not to select the second lane marking based on the reliability and the margin.
